(19) United States
(12) Patent Application Publication
(10) Pub. No.: US 2005/0274530 A1
(43) Pub. Date: Dec. 15, 2005

(54) SOD roll transfer mechanism

(76) Inventors: Gerardus J. Brouwer, Keswick (CA); Robert Milwain, Keswick (CA)

Correspondence Address: BERESKIN AND PARR, 40 KING STREET WEST, BOX 401, TORONTO, ON, M5H 3Y2, CA

(21) Appl. No.: 11/138,484

(22) Filed: May 27, 2005

Related U.S. Application Data
(60) Provisional application No. 60/574,571, filed on May 27, 2004.

(51) Int. Cl. A01B 45/04

(52) U.S. Cl. 172/19

(57) ABSTRACT

A temporary sod roll storage device for a sod harvester. The storage device has a conveyor which can have two laterally spaced belts joined by cross members to define pockets through which the bottoms of the sod rolls can protrude. Alternatively, the conveyor can have a central belt between the two side belts, preventing the bottom of the sod roll from extending below the conveyor. Support members extending partly or fully across the side belts or across all three belts then form built-up pockets on the upper surface of the conveyor to retain stably the sod rolls.

### PRIOR APPLICATION

This application claims the benefit of U.S. Provisional Application Ser. No. 60/574,571, filed May 27, 2004 entitled “SOD ROLL TRANSFER MECHANISM”.

### FIELD OF THE INVENTION

This invention relates to sod harvesters, and more particularly it relates to a temporary storage device for temporarily storing rolls of sod delivered from the harvesting mechanism, prior to disposing of the rolls of sod by placing them (for example) on a pallet or other storage device.

### BACKGROUND OF THE INVENTION

Sod harvesters are widely used for harvesting sod from fields of sod. Harvesters normally operate by undercutting a strip of sod, transporting it up a conveyor, rolling it into rolls, and then placing the rolls on a pallet. The pallet, containing a number of rolls, can then be trucked to a location where the sod is to be laid.

There has been a continuing need to automate the entire process of harvesting the sod, forming it into rolls, and stacking the rolls on a pallet. Thus, it is known to store the sod rolls temporarily on a storage device and to have an automated sod roll pick up mechanism pick up a number of sod rolls from the storage device and move them to the pallet. However, the sod rolls, when formed, can in some cases be of unstable form, and there remains a need to maintain the sod rolls in stable form on the storage device to facilitate their being picked up as a group and transferred to a pallet.

### BRIEF SUMMARY OF THE INVENTION

In one of its aspects, the present invention therefore provides a storage device for temporarily storing sod rolls, said storage device comprising a longitudinally extending conveyor having a plurality of support members extending at least partially across said conveyor, said support members being spaced apart longitudinally and defining at least a portion of a set of pockets, said support members being adapted to directly support said sod rolls in said pockets.

Further objects and advantages of the invention will appear from the following description, taken together with the accompanying drawings.

### BRIEF DESCRIPTION OF THE DRAWINGS

In the drawings:

FIG. 1 is a diagrammatic side view of a prior art sod harvester containing a temporary storage device for sod rolls;

FIG. 2 is a perspective view of a portion of a conveyor belt for a sod roll temporary storage device according to the invention;

FIG. 3 is a perspective view of the conveyor of FIG. 2 containing two sod rolls;

FIG. 4 is a side view of the conveyor of FIG. 3;

FIG. 5 is a side view of a modified version of the sod roll storage device of FIGS. 2 to 4 with sod rolls thereon;

FIG. 6 is a perspective view of a portion of the sod roll storage device of FIG. 5 with a sod roll thereon;

FIG. 7 is a perspective view of a modified support member for sod rolls; and

FIG. 8 is a perspective view of a further modification of the FIGS. 2 to 4 storage device.

### DETAILED DESCRIPTION OF PREFERRED EMBODIMENTS

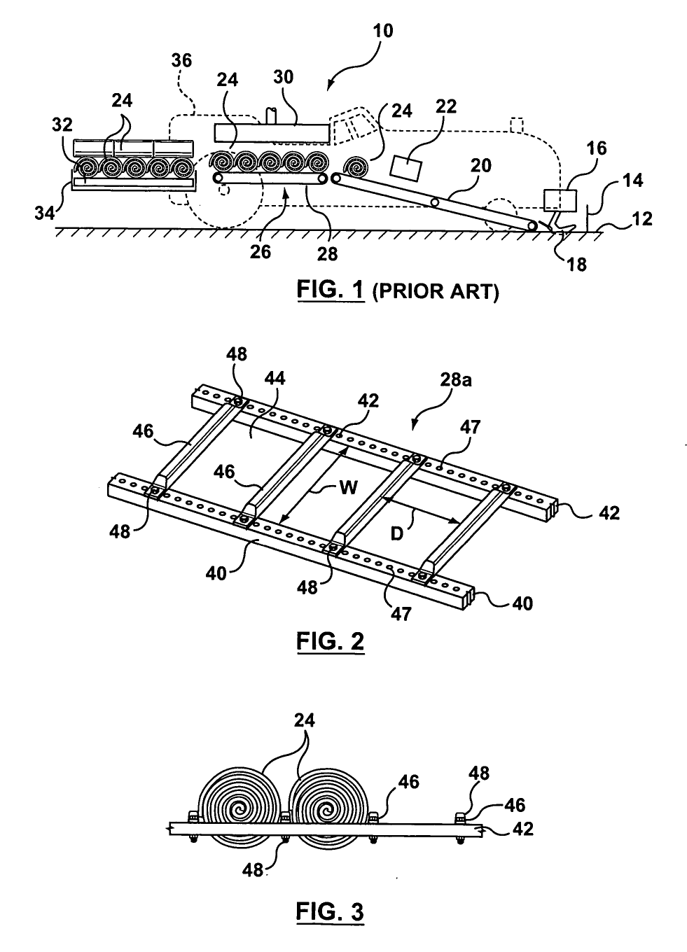

By way of background, reference is first made to FIG. 1, which shows a typical prior art sod harvester 10 harvesting sod from a sod field 12. The sod harvester 10 includes a cross-cut knife 14 to cross-cut a strip of sod, a cutting mechanism 16 which includes a knife 18 to undercut a sod strip and to cut the sides of the sod strip and to deliver the sod strip onto a conveyor 20, a sod roll up mechanism 22 to form the cut sod into sod rolls 24, and a sod roll storage device 26 having a conveyor 28 to temporarily store the sod rolls 24. The mechanism also includes a sod pick up device 30 to lift the set of sod rolls which has been stored on the storage device 26 and to move them as a set to a storage device such as a pallet 32 located in a pallet carrier 34. The entire mechanism described may be mounted on a tractor 36, or it may be built as a self-propelled machine.

In the operation of sod harvesters such as those described above, it is important that the sod rolls 24 located on the storage device 26 be maintained in stable form so that they can be picked up without difficulty by the sod roll pick up device 30 and transferred to a pallet. A prior art mechanism for accomplishing this is shown in U.S. Pat. No. 6,364,027 entitled “Sod Harvester” and issued to D. Tvetene et al., where the sod rolls are shown as located on curved portions of a conveyor belt. However, there exists a need to provide a simpler and more secure method of holding the sod rolls which are located on the storage device.

Reference is therefore next made to FIGS. 2 and 3, which show a portion of an improved storage conveyor 28a. The storage conveyor 28a comprises a pair of side belts 40 and 42, with a space or gap 44 between them which is slightly greater in width W than the length of the sod rolls 34. (The width of the sod rolls 24 is measured along the axis of the rolls.) The belts 40, 42 are typically made of a tough, flexible rubber material, which may be reinforced, for example, with internal steel wires. Such conveyor material is readily available from various commercial sources.

The belts 40, 42 are connected together by cross members 46 located at longitudinally spaced intervals along conveyor 28a. The distance D between adjacent cross members 46 is slightly smaller than the expected diameter of a sod roll 24. To enable adjustment of distance D, each belt 40, 42 contains a series of holes 47 spaced along its length. The cross members 46 are connected to belts 40, 42 by bolts 48, so that the cross members 46 can be detached from the belts and repositioned with any desired spacing D.

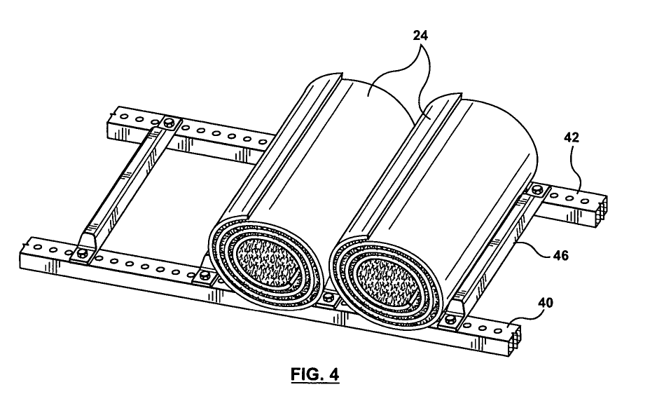

In use, the conveyor 20 delivers sod rolls 24 onto the storage conveyor 28a. As shown in FIGS. 3 and 4, the sod rolls 24 sit on the cross members 46 with the bottoms of the sod rolls projecting downwardly through the spaces 44, typically to a level below the bottoms of the belts 40, 42. In effect, the sod rolls 24 sit in pockets in the conveyor 28a, the pockets being formed by the spaces 44. As shown, the sides of the sod rolls 24 may be in light contact with each other (depending on the dimensions of the cross members 46, their longitudinal spacing D, and the diameter of the sod rolls), but this is not necessary since the sod rolls will normally be retained securely within the pockets of the conveyor 28a without the need to press against each other. The sod rolls on the conveyor 28a can then be picked up as a group and moved, for example, to the pallet 32.

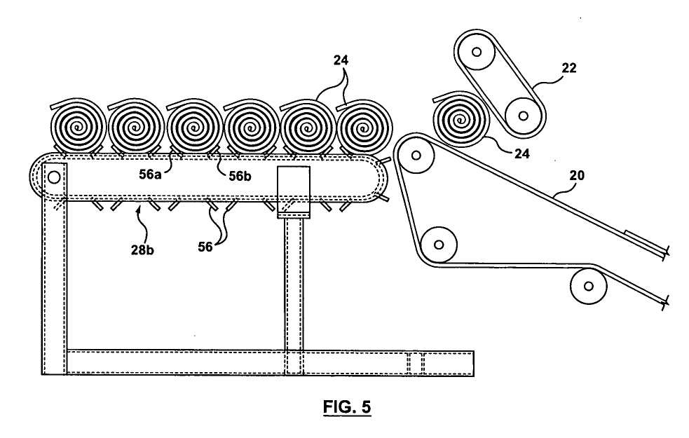

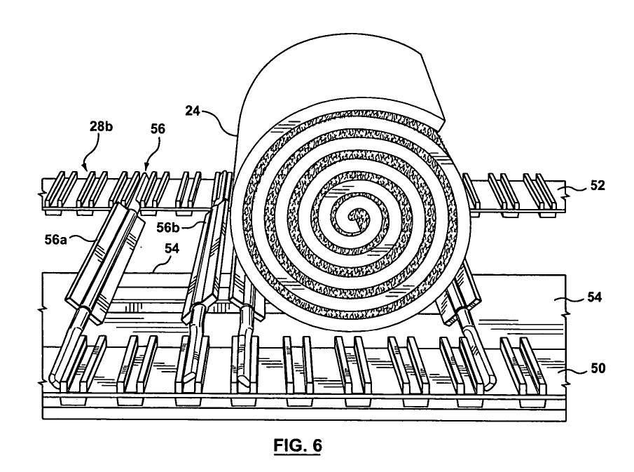

If it is preferred that the sod rolls 24 not protrude beneath the lower surface of the storage conveyor, then an arrangement can be used as shown in FIGS. 5 and 6. As there shown, the conveyor 28b includes two side belts 50, 52 spaced laterally apart, and with a central belt 54 running longitudinally between them. Cross members 56 which are longitudinally spaced apart extend across all three belts and are preferably secured to all three belts, although it is not essential that they be secured to the central belt 54. The cross members 56 are arranged in pairs, each pair consisting of two cross members 56a and 56b which slope upwardly and away from each other, to form a pocket 60 on the top of the conveyor to receive a sod roll 24. The distance D1 between the bottom of each pair of cross members 56a, 56b is smaller than the diameter of a sod roll 24, so the sod roll will sit on cross members 56a, 56b with its bottom also resting on central belt 54.

Again, although not shown in FIGS. 5 and 6, the side belts 50, 52 preferably contain a series of holes spaced along their length, and the cross members 56 are secured to the belts by bolts passing through these holes, so that distance D1 between adjacent cross members can be adjusted, depending on the diameter of the sod rolls.

In the FIGS. 5 and 6 embodiment, since the rolls sit atop the central belt 54, they can also sit on top of the side belts 50, 52. Therefore the lateral gap between the outer belts 50, 52 can be less than the length of a sod roll. If the gap between the outer belts 50, 52 is considerably less than the length of the sod roll, then the support members 56 can extend laterally beyond the side belts. Alternatively, the support members 56 can also be shorter than the length of a sod roll, in which case the pocket formed by the support members 56 will support the central portion of the sod roll.

Since the pockets defined by cross members 56 to receive the sod rolls are constructed on top of the conveyor 28b, it is not necessary that the material of the conveyor distort or curve to form a pocket, and the sod rolls are therefore retained in more stable form on the accumulator 26.

It will be seen that in the FIGS. 5, 6 embodiment, if a sod roll 24 tends to partly unwind, creating a trailing end, such trailing end of the sod roll will not drop below the conveyor 28a, since it will be blocked from doing so by at least the central belt 54.

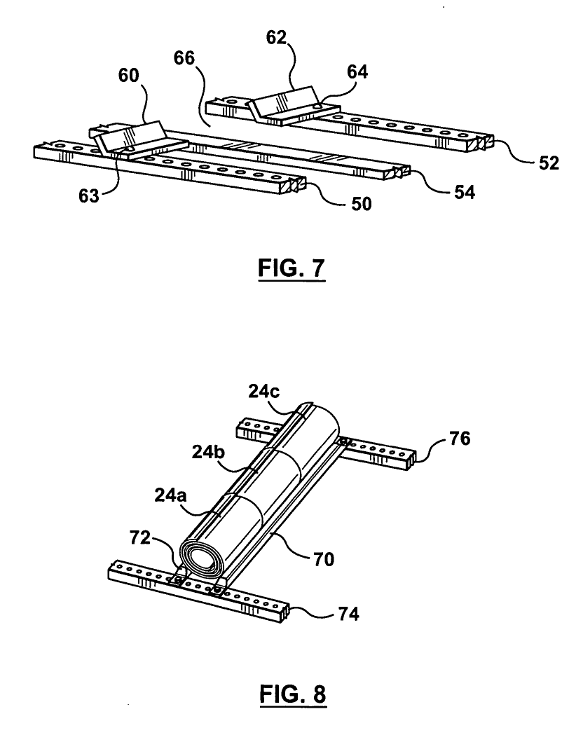

While the cross members 56 in FIGS. 5 and 6 have been shown as extending fully across all three belts, this need not be the case. As shown in FIG. 7, they can be formed as two short support members 60, 62, each fastened to a side belt 50 or 52 by bolts 63, 64 respectively with a lateral gap 66 between members 60, 62. The gap 66 does not cause a problem since the members 60, 62 are sufficient to support a sod roll.

While only a single sod roll has been shown as positioned across the conveyors described, if desired, multiple end-to-end sod rolls can be stored. An example of this is shown in FIG. 8, which shows (by way of example) three end-to-end sod rolls 24a, 24b, 24c supported in a pocket formed by elongated cross bars 70, 72 adjustably bolted to side belts 74, 76. Bars 70, 72 must be strong enough to support this weight.

While preferred embodiments of the invention have been described, it will be realized that various changes can be made within the scope of the invention.

1. A storage device for temporarily storing sod rolls, said storage device comprising a longitudinally extending conveyor having a plurality of support members extending at least partially across said conveyor, said support members being spaced apart longitudinally and defining at least a portion of a set of pockets, said support members being adapted to directly support said sod rolls in said pockets.

2. A storage device according to claim 1 wherein said conveyor comprises a pair of transmission belts spaced laterally apart with said support members extending between said belts.

3. A storage device according to claim 2 wherein the lateral spacing between said belts is greater than the length of said sod rolls, so that the bottom portions of said sod rolls may extend beneath the upper surfaces of said transmission belts.

4. A storage device according to claim 1 wherein said conveyor includes at least one belt portion having an upper surface for blocking sod from said sod roll from dropping below said upper surface, and wherein said support members extend upwardly from said upper surface to form pockets located above said upper surface.

5. A storage device according to claim 4 wherein said support members are arranged in longitudinally spaced pairs, each support member of a pair. extending upwardly and away from the other cross member of such pair.

6. A storage device according to claim 4 wherein said support members extend substantially fully across the width of said conveyor.

7. A storage device according to claim 4 wherein said support members are each formed as two laterally spaced pieces with a lateral gap between said pieces.
